(19) United States
(12) Patent Application Publication
(10) Pub. No.: US 2019/0285149 A1
(43) Pub. Date: Sep. 19, 2019

(54) BELT TENSIONER

(71) Applicant: TOYOTA JIDOSHA KABUSHIKI KAISHA, Toyota-shi (JP)

(72) Inventor: Yuki OGAWA, Toyota-shi (JP)

(73) Assignee: TOYOTA JIDOSHA KABUSHIKI KAISHA, Toyota-shi (JP)

(21) Appl. No.: 16/299,303

(22) Filed: Mar. 12, 2019

(30) Foreign Application Priority Data
Mar. 16, 2018 (JP) 2018-049317

(51) Int. Cl. F16H 7/12

(52) U.S. Cl. CPC F16H 7/1281; F16H 2007/0806

(57) ABSTRACT

A belt tensioner includes a base, a first tensioner arm, a second tensioner arm, and a coil spring. The first tensioner arm includes a first tensioner pulley, a first swing arm portion, and a first spring seat. The first swing arm portion rotatably supports the first tensioner pulley and is coupled to the base in a swingable manner. The first spring seat is pivotally supported relative to the first swing arm portion and coupled to the first end of the coil spring. The second tensioner arm includes a second tensioner pulley and a second swing arm portion. The second swing arm portion rotatably supports the second tensioner pulley and is coupled to the base in a swingable manner.

### BACKGROUND

### 1. Field

The following description relates to a belt tensioner.

### 2. Description of Related Art

Japanese Laid-Open Patent Publication No. 2017-524879 describes a typical belt tensioner that adjusts the tension of a belt running around a crank pulley of an internal combustion engine and accessory pulleys of the accessories such as a water pump, an alternator, a compressor or the like. A belt tensioner is fixed to a housing of the accessory and includes an annular base plate. A rotation shaft of the accessory is inserted through the central part of the base plate and has a distal end coupled to the accessory pulley. The belt tensioner includes two tensioner arms that are swingable relative to the base plate. The tensioner arms sandwich the accessory pulley.

Each of the tensioner arms of the typical belt tensioner includes a tensioner pulley and a swing arm portion that has a first end coupled to the tensioner pulley to rotatably support the tensioner pulley. The tensioner pulley contacts the belt, which runs around the accessory pulley, and pushes the belt inward from the outer side. The swing arm portion is coupled to a swing shaft that is fixed to the base plate. The swing arm portion is swingable about the swing shaft relative to the base plate.

In the typical belt tensioner, the swing arm portion of one of the two tensioner arms is coupled to one end of a coil spring, and the swing arm portion of the other tensioner arm is coupled to the other end of the coil spring. The coil spring is located between the swing arm portions in a compressed state and biased in directions in which the swing arm portions move away from each other. The biasing force of the coil spring swings the swing arm portions and biases the tensioner pulleys of the tensioner arms in directions in which the tensioner pulleys move toward each other. As a result, the tensioner pulleys are pushed against the belt from the outer side. The tensioner pulleys push the belt and apply tension to the belt.

When rotation fluctuations of the crank pulley or the like temporarily increase the tension of the belt, the pressing force of the belt applied to the tension pulleys increases. This swings the swing arm portions in directions in which the coil spring is compressed against the biasing force of the coil spring. This moves the tensioner pulleys outward and decreases the tension of the belt so as to prevent the tension of the belt from being excessively high. In contrast, when the tension of the belt is temporarily decreased, the pressing force of the belt applied to the tensioner pulleys decreases. Accordingly, the biasing force of the coil spring moves the tensioner pulleys inward to increase the tension of the belt so as to prevent the tension of the belt from being excessively low.

In the typical belt tensioner described in the above patent document, the coil spring, which is located between two tensioner arms, is compressed and stretched in accordance with the swinging of the tensioner arms. The coil spring is fixed to the ends of the tensioner arms. Thus, when the tensioner arms swing, the compressing force of each tensioner arm is applied to the coil spring in swinging directions. Depending on where the end of each tensioner arm is located, the swing direction of the end of the tensioner arm may differ from the axial direction of the coil spring. In this case, the force of the tensioner arms acting to compress the coil spring may increase the pitch change rate at certain locations. This may result in a coil abutment state in which the coils are pressed against one another in part of the spring coil. When the coil spring is in the coil abutment state, the effective length of the coil spring is decreased, and the actual spring constant is increased as compared to when the coil spring is not in the coil abutment state. Such a situation adversely affects the response of the tensioner arms to changes in the tension of the belt.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a belt tensioner that solves the above problem includes a base, a first tensioner arm and a second tensioner arm that are supported by the base in a swingable manner, and a coil spring. The coil spring includes a first end that is coupled to the first tensioner arm, and a second end that is coupled to the second tensioner arm. The first tensioner arm includes a first tensioner pulley, a first swing arm portion, and a first spring seat. The first tensioner arm is in contact with a belt that is running around a crank pulley. The first swing arm portion rotatably supports the first tensioner pulley and is coupled to the base in a swingable manner. The first spring seat is pivotally supported relative to the first swing arm portion and coupled to the first end of the coil spring. The second tensioner arm includes a second tensioner pulley and a second swing arm portion. The second tensioner pulley is in contact with the belt. The second swing arm portion rotatably supports the second tensioner pulley and is coupled to the base in a swingable manner.

### BRIEF DESCRIPTION OF THE DRAWINGS

FIG. 1 is a schematic side view showing the structure of a belt tensioner coupled to an internal combustion engine.

FIG. 2 is an enlarged side view showing the structure of the belt tensioner.

FIG. 3 is an enlarged view showing the structure near a coil spring of the belt tensioner.

FIG. 4 is a side view illustrating an example of movement of the belt tensioner.

FIG. 5 is a side view illustrating another example of movement of the belt tensioner.

FIG. 6 is an enlarged view showing the structure near a coil spring of a belt tensioner of a comparative example.

FIG. 7 is an enlarged view showing an example of flex of a coil spring of a belt tensioner of another comparative example.

FIG. 8 is a schematic side view showing the structure of a belt tensioner in accordance with a modified example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

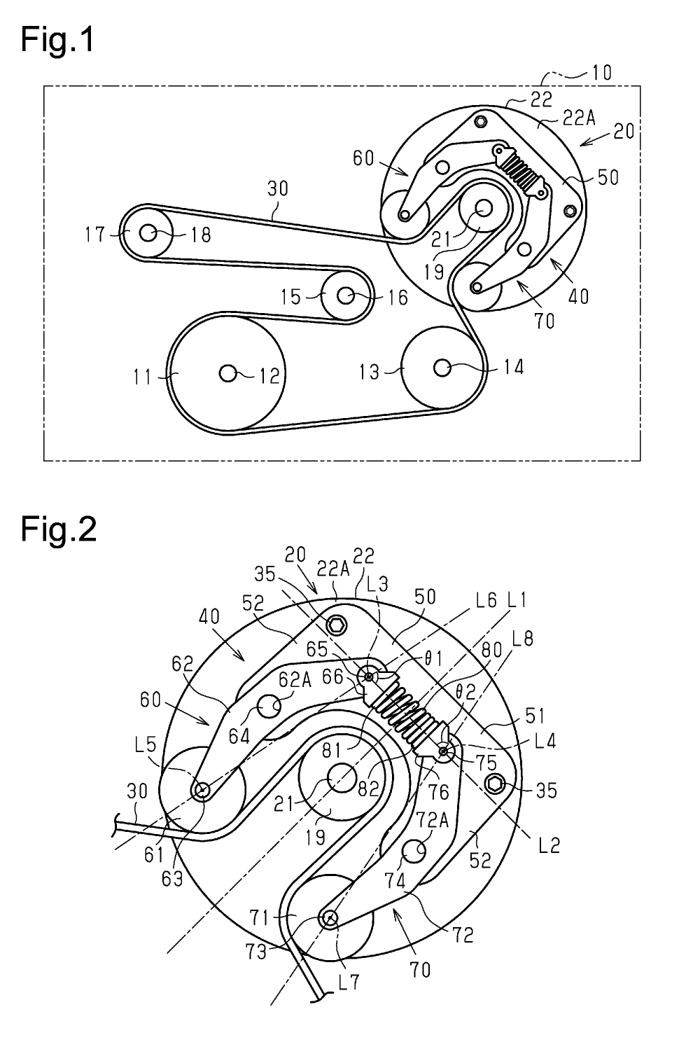

One embodiment of a belt tensioner will now be described with reference to FIGS. 1 to 6.

As shown in FIG. 1, an internal combustion engine includes an engine body 10 that has a side where a crank pulley 11 is arranged. The crank pulley 11 has the form of a disc. A crankshaft 12 includes an end that is inserted through the center of the crank pulley 11. The crankshaft 12 includes a first end that is coupled to the crank pulley 11 and located outside the engine body 10. A portion of the crankshaft 12 extending from the first end toward a second end (toward the side underneath plane of FIG. 1) is located inside the engine body 10. The crankshaft 12 is rotatably supported by the engine body 10. The crank pulley 11 is rotated by rotation of the crankshaft 12. A first accessory pulley 13 is arranged sideward (rightward in FIG. 1) from the crank pulley 11. The first accessory pulley 13 has the form of a disc. A first driveshaft 14 for a compressor of an air conditioning device is inserted through the center of the first accessory pulley 13. The first driveshaft 14 is rotated integrally with the first accessory pulley 13.

An idler pulley 15 is arranged between the crank pulley 11 and the first accessory pulley 13 and upward from the crank pulley 11 and the first accessory pulley 13. The idler pulley 15 has the form of a disc. A rotation shaft 16 is inserted through the center of the idler pulley 15. The rotation shaft 16 is fixed to a side surface of the engine body 10. The idler pulley 15 is rotatable about the rotation shaft 16. A second accessory pulley 17 is arranged at a position located upward from the idler pulley 15 and toward the crankshaft 12 from the idler pulley 15 (leftward in FIG. 1). In one example, the second accessory pulley 17 is arranged at a position separated from the idler pulley 15 and located toward the crankshaft 12 (leftward in FIG. 1). The second accessory pulley 17 has the form of a disc. A second driveshaft 18 for a water pump is inserted through the center of the second accessory pulley 17. The second driveshaft 18 is rotated integrally with the second accessory pulley 17. Further, a third accessory pulley 19 is arranged at a position located upward from the idler pulley 15 and toward the first accessory pulley 13 from the idler pulley 15 (rightward in FIG. 1). In one example, the third accessory pulley 19 is arranged at a position separated from the idler pulley 15 and located toward the first accessory pulley 13 (rightward in FIG. 1). The third accessory pulley 19 has the form of a disc. A third driveshaft 21 for a motor generator 20 is inserted through the center of the third accessory pulley 19. The third driveshaft 21 is rotated integrally with the third accessory pulley 19.

An annular belt 30 runs around the crank pulley 11, the first accessory pulley 13, the idler pulley 15, the second accessory pulley 17, and the third accessory pulley 19. The belt 30 runs around the crank pulley 11, the first accessory pulley 13, the second accessory pulley 17, and the third accessory pulley 19 from the outer side. Further, the belt 30 runs around the idler pulley 15 from the inner side. The belt 30 transmits rotational torque of the crank pulley 11 to other pulleys.

The motor generator 20 includes a housing 22 that rotatably supports the third driveshaft 21. The housing 22 is cylindrical and has a closed bottom end. The housing 22 includes a side 22A where a belt tensioner 40 is fixed.

As shown in FIG. 2, the belt tensioner 40 includes a plate-like base 50 that is fixed to the side 22A of the housing 22 of the motor generator 20. The base 50 includes a fixed portion 51 and two support portions 52 that are bent and extend from two ends of the fixed portion 51. The support portions 52 are spaced apart from each other, and the third accessory pulley 19 is located between the two support portions 52. The two ends of the fixed portion 51 each include a bolt hole (not shown). Bolts 35 are inserted through the bolt holes and fastened to the side 22A of the housing 22 of the motor generator 20 in order to fasten the base 50 to the housing 22.

The belt tensioner 40 includes a first tensioner arm 60 and a second tensioner arm 70 that are coupled to the base 50. The first tensioner arm 60 is located upward from the third accessory pulley 19 and the second tensioner arm 70 is located downward from the third accessory pulley 19. The first tensioner arm 60 and the second tensioner arm 70 are symmetrically arranged relative to an axis L1.

The first tensioner arm 60 includes a first tensioner pulley 61 that is in contact with the belt 30. The first tensioner pulley 61 has the form of a disc. The first tensioner pulley 61 is coupled to a first swing arm portion 62. The first swing arm portion 62 is plate-like and bent to be arcuate so that a central part is farther from the third accessory pulley 19 than other parts in the side view of FIG. 2 showing the belt tensioner 40. The first swing arm portion 62 includes a first end that extends farther from the support portion 52 of the base 50 in a direction in which the axis L1 extends (hereafter, referred to as “the first axial direction”). A first support shaft 63 is coupled to the first end of the first swing arm portion 62. The first support shaft 63 is inserted through the center of the first tensioner pulley 61 to rotatably support the first tensioner pulley 61. That is, the first end of the first swing arm portion 62 is coupled to the first tensioner pulley 61 to rotatably support the first tensioner pulley 61. The first swing arm portion 62 includes a first insertion hole 62A in a central part. A first swing shaft 64 is inserted through the first insertion hole 62A. The first swing shaft 64 projects from the support portion 52 of the base 50. The first swing arm portion 62 is supported by the base 50 to be swingable about the first swing shaft 64.

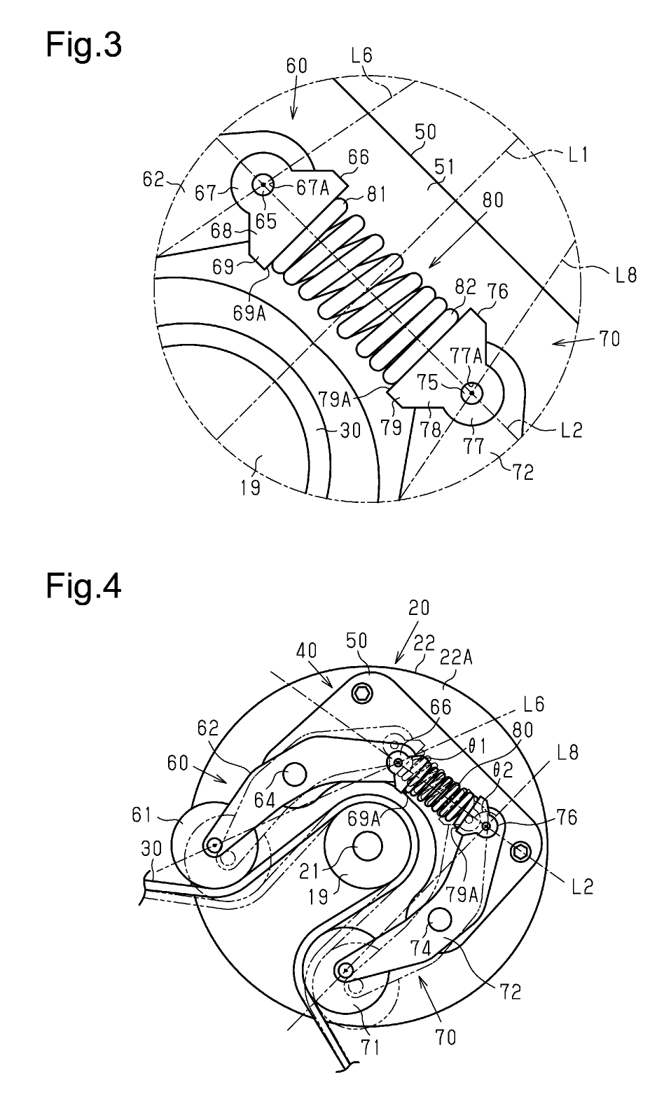

As shown in FIG. 3, the first swing arm portion 62 includes a second end from where a first pivot shaft 65 projects. The first pivot shaft 65 is inserted through a first support hole 67A in a first spring seat 66. The first spring seat 66 includes a first support end 67, a first tapered part 68, and a first opposing end 69. The first support end 67 includes the first support hole 67A. The first tapered part 68 is located closer to the second tensioner arm 70 than the first support end 67. The first opposing end 69 is located closer to the second tensioner arm 70 than the first tapered part 68. The first support end 67 is cylindrical. In a state arranged at the position shown in FIG. 3, the first tapered part 68 is shaped to be a triangular column having a length in the first axial direction that increases from the first support end 67 towards the first opposing end 69. The first opposing end 69 has the form of a rectangular column. The first spring seat 66 is supported by the first swing arm portion 62 to be pivotal about the first pivot shaft 65 relative to the first swing arm portion 62.

As shown in FIG. 2, the second tensioner arm 70 includes a second tensioner pulley 71 that is in contact with the belt 30. The second tensioner pulley 71 has the form of a disc. The second tensioner pulley 71 is coupled to a second swing arm portion 72. The second swing arm portion 72 is plate-like and bent to be arcuate so that a central part is farther from the third accessory pulley 19 than other parts in the side view of FIG. 2 showing the belt tensioner 40. The second swing arm portion 72 includes a first end that extends farther from the support portion 52 of the base 50 in the first axial direction. A second support shaft 73 is coupled to the first end of the second swing arm portion 72. The second support shaft 73 is inserted through the center of the second tensioner pulley 71 to rotatably support the second tensioner pulley 71. That is, the first end of the second swing arm portion 72 is coupled to the second tensioner pulley 71 to rotatably support the second tensioner pulley 71. The second swing arm portion 72 includes a second insertion hole 72A in a central part. A second swing shaft 74 is inserted through the second insertion hole 72A. The second swing shaft 74 projects from the support portion 52 of the base 50. The second swing arm portion 72 is supported by the base 50 to be swingable about the second swing shaft 74.

As shown in FIG. 3, the second swing arm portion 72 includes a second end from where a second pivot shaft 75 projects. The second pivot shaft 75 is inserted through a second support hole 77A in a second spring seat 76. The second spring seat 76 includes a second support end 77, a second tapered part 78, and a second opposing end 79. The second support end 77 includes the second support hole 77A. The second tapered part 78 is located closer to the first tensioner arm 60 than the second support end 77. The second opposing end 79 is located closer to the first tensioner arm 60 than the second tapered part 78. The second support end 77 is cylindrical. In a state arranged at the position shown in FIG. 2, the second tapered part 78 is shaped to be a triangular column having a length in the first axial direction that increases from the second support end 77 towards the second opposing end 79. The second opposing end 79 has the form of a rectangular column. The second spring seat 76 is supported by the second swing arm portion 72 to be pivotal about the second pivot shaft 75 relative to the second swing arm portion 72. A second opposing surface 79A of the second opposing end 79 of the second spring seat 76 and a first opposing surface 69A of the first opposing end 69 of the first spring seat 66 are parallel to each other and opposing each other.

As shown in FIGS. 2 and 3, a coil spring 80 is coupled to the belt tensioner 40. The coil spring 80 includes a first end 81 that is coupled to the first tensioner arm 60 and a second end 82 that is coupled to the second tensioner arm 70. The coil spring 80 is located between the first tensioner arm 60 and the second tensioner arm 70 in a compressed state. The first end 81 of the coil spring 80 is coupled to the first opposing end 69 of the first spring seat 66 of the first tensioner arm 60. Further, the second end 82 of the coil spring 80 is coupled to the second opposing end 79 of the second spring seat 76 of the second tensioner arm 70. In the state shown in FIG. 2, an axis L2 of the coil spring 80 (hereafter, referred to as “the second axial direction”) extends in a direction that is orthogonal to the first axial direction. The first opposing surface 69A of the first opposing end 69 and the second opposing surface 79A of the second opposing end 79 are parallel to the first axial direction. Further, the axis L2 of the coil spring 80 intersects with an axis L3 of the first pivot shaft 65 and an axis L4 of the second pivot shaft 75.

As shown in FIG. 2, in the first tensioner arm 60, a hypothetical line L6 extends straight through an axis L5 of the first support shaft 63 and the axis L3 of the first pivot shaft 65. Hereafter, an angle between the hypothetical line L6 and the axis L2 of the coil spring 80 will be referred to as a coupling angle θ1 of the coil spring 80 relative to the first tensioner arm 60. Further, in the second tensioner arm 70, a hypothetical line L8 extends straight through an axis L7 of the second support shaft 73 and the axis L4 of the second pivot shaft 75. Hereafter, an angle between the hypothetical line L8 and the axis L2 of the coil spring 80 will be referred to as a coupling angle 82 of the coil spring 80 relative to the second tensioner arm 70.

The coil spring 80 biases the second end of the first swing arm portion 62 and the second end of the second swing arm portion 72 away from each other. That is, the biasing force of the coil spring 80 swings the first swing arm portion 62 of the first tensioner arm 60 about the first swing shaft 64 so that the first tensioner pulley 61 is pressed against the belt 30 from the outer side. Further, the biasing force of the coil spring 80 swings the second swing arm portion 72 of the second tensioner arm 70 about the second swing shaft 74 so that the second tensioner pulley 71 is pressed against the belt 30 from the outer side. In this manner, the first tensioner pulley 61 and the second tensioner pulley 71 press the belt 30 and apply tension to the belt 30.

For example, when the internal combustion engine is running, torque fluctuations of the crankshaft 12 or the like may cause the tension of the belt 30 at the portion contacting the first tensioner pulley 61 of the first tensioner arm 60 to be higher than the tension of the belt 30 at the portion contacting the second tensioner pulley 71 of the second tensioner arm 70.

In such a case, as shown in FIG. 4, the belt 30 presses the first tensioner pulley 61 and swings the first swing arm portion 62 of the first tensioner arm 60 against the biasing force of the coil spring 80. Accordingly, the first tensioner pulley 61 of the first tensioner arm 60 is moved toward the outer side of the belt 30 as shown by the solid lines in FIG. 4 from the pre-swing state shown by the double-dashed lines in FIG. 4. This decreases the tension of the belt 30.

Further, with the second tensioner arm 70, as the tension of the belt 30 decreases, the biasing force of the coil spring 80 swings the second swing arm portion 72. Accordingly, the second swing arm portion 72 of the second tensioner arm 70 moves the second tensioner pulley 71 toward the inner side of the belt 30 as shown in solid lines in FIG. 4, from the pre-swing state shown by the double-dashed lines in FIG. 4. This increases the tension of the belt 30.

In this manner, in a state in which the first tensioner arm 60 and the second tensioner arm 70 are swung as shown by the solid lines in FIG. 4, the relative positions of the first spring seat 66 and the second spring seat 76 are changed from the pre-swing state shown by the double-dashed lines in FIG. 4. In this case, the first spring seat 66 is pivoted relative to the first swing arm portion 62 to decrease the coupling angle θ1 of the coil spring 80 relative to the first tensioner arm 60. Further, the second spring seat 76 is pivoted relative to the second swing arm portion 72 to increase the coupling angle θ2 of the coil spring 80 relative to the second tensioner arm 70. This maintains the first opposing surface 69A of the first opposing end 69 and the second opposing surface 79A of the second opposing end 79 in an opposing state toward each other. In this state, the axis L2 of the coil spring 80 intersects with the axis L3 of the first pivot shaft 65 and the axis L4 of the second pivot shaft 75.

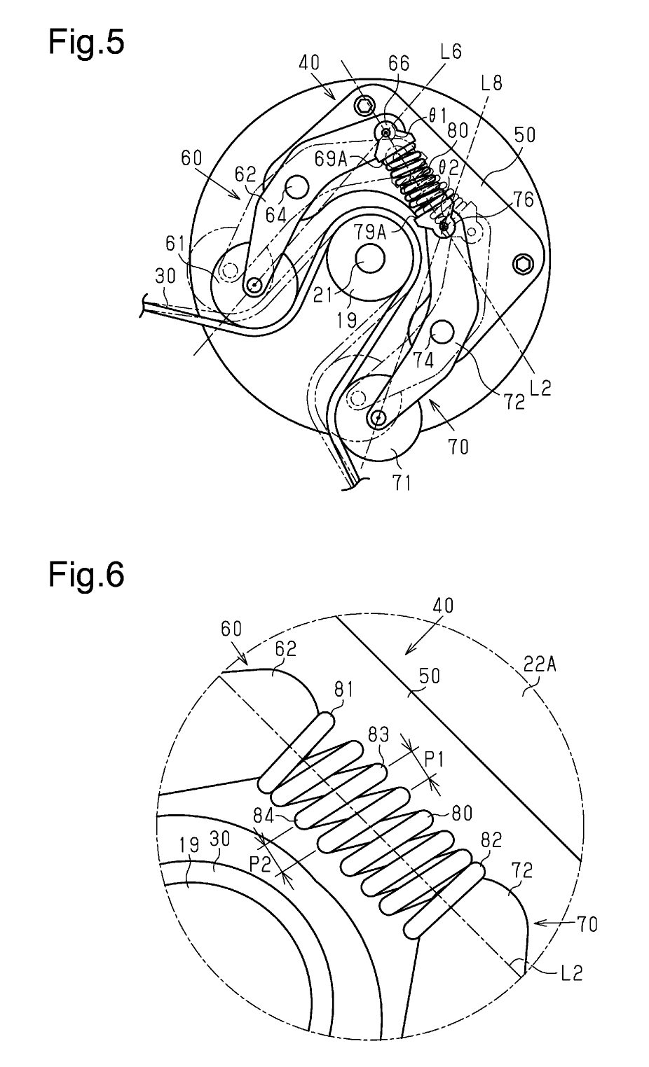

For example, when starting the internal combustion engine, the motor generator 20 is driven to rotate the third accessory pulley 19. This transmits rotational torque of the motor generator 20 via the belt 30 to the crankshaft 12. In this case, the tension of the belt 30 where the belt 30 contacts the first tensioner pulley 61 of the first tensioner arm 60 is lower than the tension of the belt 30 where the belt 30 contacts the second tensioner pulley 71 of the second tensioner arm 70. With the belt tensioner 40, as shown in FIG. 5, the belt 30 presses the second tensioner pulley 71 and swings the second swing arm portion 72 of the second tensioner arm 70 against the biasing force of the coil spring 80. As shown by the solid lines in FIG. 5, the second tensioner pulley 71 of the second tensioner arm 70 is moved toward the outer side of the belt 30 from the pre-swing state shown by the double-dashed liens in FIG. 5 and decreases the tension of the belt 30.

Further, with the first tensioner arm 60, the biasing force of the coil spring 80 swings the first swing arm portion 62 when the tension of the belt 30 decreases. Accordingly, as shown by the solid lines in FIG. 5, the first swing arm portion 62 of the first tensioner arm 60 moves the first tensioner pulley 61 toward the inner side of the belt 30 from the pre-swing state shown by the double-dashed lines in FIG. 5 and increases the tension of the belt 30.

In this manner, in a state in which the first tensioner arm 60 the second tensioner arm 70 are swung as shown by the solid lines in FIG. 5, the relative positions of the first spring seat 66 and the second spring seat 76 are changed from the pre-swing state shown by the double-dashed lines in FIG. 5. In this case, the first spring seat 66 is pivoted relative to the first swing arm portion 62 to increase the coupling angle θ1 of the coil spring 80 relative to the first tensioner arm 60, and the second spring seat 76 is pivoted relative to the second swing arm portion 72 to decrease the coupling angle θ2 of the coil spring 80 relative to the second tensioner arm 70. This maintains the end surface of the first opposing end 69 and the end surface of the second opposing end 79 in an opposing state toward each other. In such a state, the axis L2 of the coil spring 80 intersects with the axis L3 of the first pivot shaft 65 and the axis L4 of the second pivot shaft 75.

The operation and advantages of the present embodiment will now be described.

(1) In the present embodiment, the first spring seat 66 of the first tensioner arm 60 is coupled to the first end 81 of the coil spring 80. The first spring seat 66 is pivotal relative to the first swing arm portion 62. A comparative example will now be described to show structural differences from the present embodiment. In the comparative example, the first tensioner arm 60 does not include the first spring seat 66, and the second tensioner arm 70 does not include the second spring seat 76. In the structure of the comparative example, the first swing arm portion 62 of the first tensioner arm 60 is fixed to the first end 81 of the coil spring 80, and the second swing arm portion 72 of the second tensioner arm 70 is fixed to the second end 82 of the coil spring 80.

As shown in FIG. 6, in the structure of the comparative example, when the first tensioner arm 60 and the second tensioner arm 70 are pressed by the belt 30 substantially in the same manner, the axis L2 of the coil spring 80 extends straight. In this state, pitch P1 at a first part 83 of the coil spring 80 is substantially equal to pitch P2 at a second part 84 separated by 180° from the first part 83 in a circumferential direction.

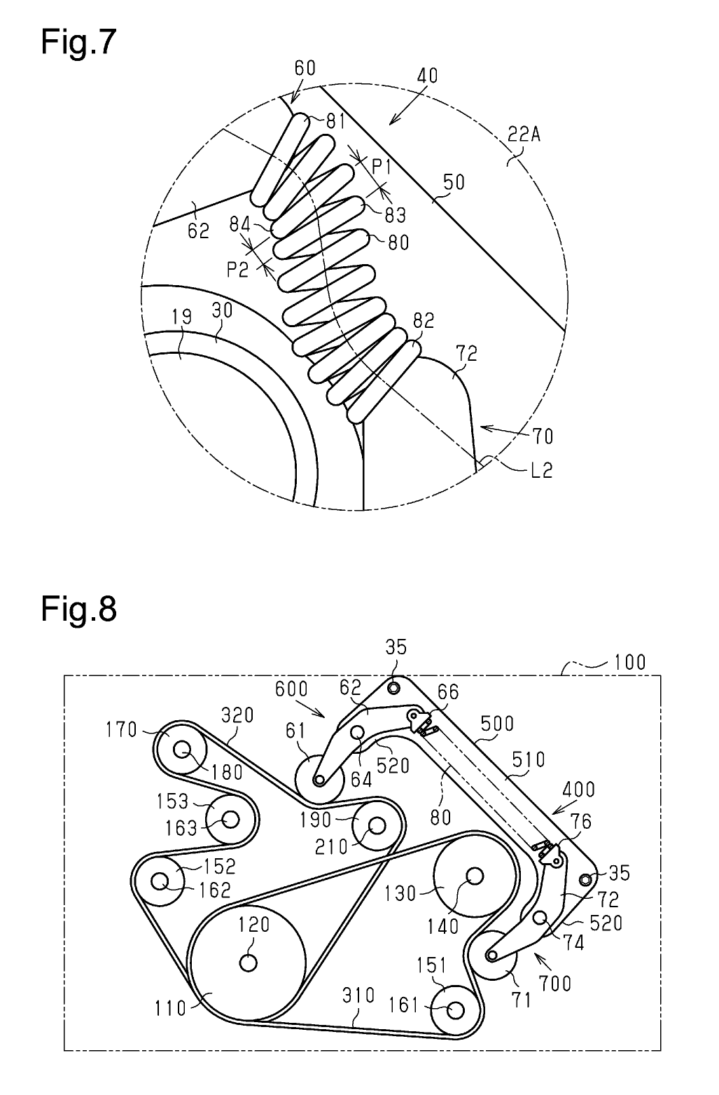

As shown in FIG. 7, the coil spring 80 is twisted when the first tensioner arm 60 is pivoted by the biasing force of the coil spring 80 and the second tensioner arm 70 is pivoted against the biasing force of the coil spring 80. In this state, the axis L2 of the coil spring 80 is curved as shown by the dashed line in FIG. 7. Accordingly, as shown in FIG. 7, the pitch P1 at the first part 83 of the coil spring 80 becomes greater than pitch P2 of the second part 84. This partially changes pitches of the coil spring 80 when the coil spring 80 is compressed and stretched. With the structure of the comparative example, when the coil spring 80 is twisted, coil abutment occurs at the first end 81 and the second end 82. This increases the actual spring constant of the coil spring 80 thereby decreasing the swing amount of the first tensioner arm 60 and the second tensioner arm 70 as compared to when the coil spring 80 is not twisted and the same amount of force is applied.

In the present embodiment, as shown in FIGS. 4 and 5, when the first tensioner arm 60 swings, the elastic force of the coil spring 80 pivots the first spring seat 66 relative to the first swing arm portion 62. This changes the coupling angle 81 of the coil spring 80 relative to the first tensioner arm 60. Such a change in the coupling angle θ1 restricts twisting of the coil spring 80 and arranges the coil spring 80 so that the axis L2 of the coil spring 80 is straight. This maintains the pitch of the coil spring 80 when the coil spring 80 is compressed and stretched and limits the occurrence of coil abutment in the coil spring 80. In this manner, the coil spring 80 will not be twisted by the arrangement of the first tensioner arm 60 and the second tensioner arm 70 and decrease the swing amount of the first tensioner arm 60 and the second tensioner arm 70. This limits deterioration in the response of the belt tensioner 40 relative to the changes in the tension of the belt 30. Consequently, this prevents the belt 30 from slipping on the pulleys.

(2) The second spring seat 76 of the second tensioner arm 70 is coupled to the second end 82 of the coil spring 80. The second spring seat 76 is pivotal relative to the second swing arm portion 72. When the second tensioner arm 70 swings, the elastic force of the coil spring 80 pivots the second spring seat relative to the second swing arm portion 72 to change the coupling angle θ2 of the coil spring 80 relative to the second tensioner arm 70. Accordingly, the first end 81 of the coil spring 80 is coupled to the first spring seat 66 that is pivotally supported relative to the first swing arm portion 62. Further, the second end 82 of the coil spring 80 is coupled to the second spring seat 76 that is pivotally supported relative to the second swing arm portion 72. In this manner, when the coil spring 80 is compressed and stretched between the first tensioner arm 60 and the second tensioner arm 70, the axis L2 of the coil spring 80 will be straight regardless of the positions of the first tensioner arm 60 and the second tensioner arm 70.

The present embodiment may be modified as follows. The present embodiment and the following modifications can be combined as long as the combined modifications remain technically consistent with each other.

The first spring seat 66 and the second spring seat 76 may have any shape. For example, the first spring seat 66 may only be configured by the first support end 67 that is cylindrical. Further, the first spring seat 66 may be spherical. As long as the first spring seat 66 is pivotal relative to the first swing arm portion 62 and the second spring seat 76 is pivotal relative to the second swing arm portion 72, the first spring seat 66 and the second spring seat 76 may have any shape.

In the above embodiment, the first tensioner arm 60 is arranged upward from the third accessory pulley 19 and the second tensioner arm 70 is arranged downward from the third accessory pulley 19. However, the arrangement of the first tensioner arm 60 and the second tensioner arm 70 are not limited as described above. For example, the first tensioner arm 60 may be arranged leftward from the third accessory pulley 19, and the second tensioner arm 70 may be arranged rightward from the third accessory pulley 19.

The second spring seat 76 may be omitted from the second tensioner arm 70. In this case, the second end 82 of the coil spring 80 is coupled to the second swing arm portion 72 of the second tensioner arm 70. When applying this structure to the above embodiment, the tensioner arm arranged downward from the third accessory pulley 19 does not include a seat. Further, when applying this structure to the belt tensioner in which the first tensioner arm 60 is arranged downward from the third accessory pulley 19 and the second tensioner arm 70 is arranged upward from the third accessory pulley 19, the tensioner arm arranged upward from the third accessory pulley 19 does not include a seat.

In the above embodiment, the base 50 is fixed to the side 22A of the housing 22. However, the base 50 may be fixed at other locations. For example, the base 50 may be fixed to a side surface of the engine body 10.

In the above embodiment, the belt tensioner 40 is arranged so that the first tensioner arm 60 and the second tensioner arm 70 sandwich the third accessory pulley 19. However, the first tensioner arm 60 and the second tensioner arm 70 may be arranged in any manner. For example, the configuration shown in FIG. 8 may be employed.

As shown in FIG. 8, an internal combustion engine includes an engine body 100 that has a side where a crank pulley 110 is arranged. A crankshaft 120 includes an end that is inserted through the center of the crank pulley 110. The crankshaft 120 is rotatably supported by the engine body 100. The crank pulley 110 is rotated by the rotation of the crankshaft 120. A first accessory pulley 130 is arranged toward the upper right side of the crank pulley 110. A first driveshaft 140 for a compressor of an air conditioning device is inserted through the center of the first accessory pulley 130. The first driveshaft 140 is rotated integrally with the first accessory pulley 130.

A first idler pulley 151 is arranged downward from the first accessory pulley 130. A first rotation shaft 161 is inserted through the center of the first idler pulley 151. A first rotation shaft 161 is fixed to the side surface of the engine body 100. The first idler pulley 151 is rotatable about the first rotation shaft 161. An annular first belt 310 runs around the crank pulley 110, the first accessory pulley 130, and the first idler pulley 151. The first belt 310 runs to surround the crank pulley 110, the first accessory pulley 130, and the first idler pulley 151 from the outer side. The first belt 310 transmits rotational torque of the crank pulley 110 to the first accessory pulley 130.

A second idler pulley 152 is arranged toward the upper left side of the crank pulley 110. A rotation shaft 162 is inserted through the center of the second idler pulley 152. The rotation shaft 162 is fixed to the side surface of the engine body 100. A third idler pulley 153 is arranged at the upper right side of the second idler pulley 152. A third rotation shaft 163 is inserted through the center of the third idler pulley 153. The third rotation shaft 163 is fixed to the side surface of the engine body 100.

A second accessory pulley 170 is arranged at the upper left part of the third idler pulley 153. A second driveshaft 180 for a water pump is inserted through the center of the second accessory pulley 170. The second driveshaft 180 is rotated integrally with the second accessory pulley 170. Further, a third accessory pulley 190 is arranged rightward from the third idler pulley 153. A third driveshaft 210 of an alternator is inserted through the center of the third accessory pulley 190. The third driveshaft 210 is rotated integrally with the third accessory pulley 190.

An annular second belt 320 runs around the crank pulley 110, the second idler pulley 152, the third idler pulley 153, the second accessory pulley 170, and the third accessory pulley 190. The second belt 320 runs to surround the crank pulley 110, the second idler pulley 152, the second accessory pulley 170, and the third accessory pulley 190 from the outer side. Further, the second belt 320 runs around the third idler pulley 153 from the inner side. The second belt 320 transmits rotational torque of the crank pulley 110 to the second accessory pulley 170 and the third accessory pulley 190. The second belt 320 is arranged closer to the engine body 100 than the first belt 310.

A belt tensioner 400 is fixed to the side of the engine body 100. The belt tensioner 400 includes a plate-like base 500 that is fixed to the engine body 100. The base 500 includes a fixed portion 510 and two support portions 520 that are bent and extend from the ends of the fixed portion 510. The fixed portion 510 extends from the first accessory pulley 130 to the third accessory pulley 190. The two support portions 520 are spaced apart from each other, and the first accessory pulley 130 and the third accessory pulley 190 are located between the two support portions 520. The fixed portion 510 is fixed to the engine body 100 by the bolts 35.

The belt tensioner 400 includes a first tensioner arm 600 and a second tensioner arm 700 that are coupled to the base 500. The first tensioner arm 600 has the same structure as the first tensioner arm 60 in the above embodiment. Further, the second tensioner arm 700 has the same structure as the second tensioner arm 70 in the above embodiment. The first tensioner pulley 61 of the first tensioner arm 600 is in contact with the second belt 320 between the second accessory pulley 170 and the third accessory pulley 190. The second tensioner pulley 71 of the second tensioner arm 700 is in contact with the first belt 310 between the first accessory pulley 130 and the first idler pulley 151. With such a structure, when the first tensioner arm 600 swings, the elastic force of the coil spring 80 pivots the first spring seat 66 relative to the first swing arm portion 62. Further, when the second tensioner arm 700 swings, the elastic force of the coil spring 80 pivots the second spring seat 76 relative to the second swing arm portion 72. This changes the coupling angle θ of the coil spring 80 relative to the first tensioner arm 600 and the coupling angle θ2 of the coil spring 80 relative to the second tensioner arm 700. Thus, the modified example has the same advantages as the above embodiment.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A belt tensioner, comprising:
a base;
a first tensioner arm and a second tensioner arm that are supported by the base in a swingable manner; and
a coil spring that includes a first end that is coupled to the first tensioner arm and a second end that is coupled to the second tensioner arm, wherein
the first tensioner arm includes a first tensioner pulley that is in contact with a belt running around a crank pulley, a first swing arm portion that rotatably supports the first tensioner pulley and is coupled to the base in a swingable manner, and a first spring seat that is pivotally supported relative to the first swing arm portion and coupled to the first end of the coil spring, and
the second tensioner arm includes a second tensioner pulley that is in contact with the belt and a second swing arm portion that rotatably supports the second tensioner pulley and is coupled to the base in a swingable manner.

2. The belt tensioner according to claim 1, wherein the second swing arm portion further includes a second spring seat that is pivotally supported relative to the second swing arm portion and coupled to the second end of the coil spring.
